(19) United States
(12) Patent Application Publication
(10) Pub. No.: US 2021/0380235 A1
(43) Pub. Date: Dec. 9, 2021

(54) BREACHING FOR SUBMERGIBLE FIXED WING AIRCRAFT

(71) Applicant: Evangelos Livieratos, Medford, MA (US)

(72) Inventor: Evangelos Livieratos, Medford, MA (US)

(21) Appl. No.: 17/404,960

(22) Filed: Aug. 17, 2021

Related U.S. Application Data
(63) Continuation of application No. PCT/US20/18704, filed on Feb. 18, 2020.
Application No. PCT/US20/18704 is a continuation-in-part of application No. 16/396,633, filed on Apr. 26, 2019.
(60) Provisional application No. 62/806,956, filed on Feb. 18, 2019.
(60) Provisional application No. 62/806,956, filed on Feb. 18, 2019.
(60) Provisional application No. 62/671,515, filed on May 15, 2018.

(51) Int. Cl. B64C 35/00; B64C 3/28; B64C 3/38; B64D 27/24; B64C 5/02; G05D 1/10; B64C 11/30

(52) U.S. Cl. CPC B64C 35/005; B64C 3/28; B64C 3/38; B64D 27/24; B64C 11/30; B64C 5/02; B64C 35/008; G05D 1/101; B64C 35/007

(57) ABSTRACT

A vehicle architecture and the associated method of operation for fixed wing aircraft transition from operation underwater to flight in air. More particularly, the vehicle architecture and method allow transition and long-range operation in both water and in air.

The method starts with the vehicle oriented for long range flight in water. The method is composed of a flight orientation change for high speed ascent by rolling over, then water ascent, tractor propeller transition, wing transition, pusher propeller transition, boundary layer flight, and air ascent. The vehicle will ascend in its highspeed water configuration. As the tractor propeller breaches the surface of the water it will change its pitch collectively to optimize for low speed operation in air. As the wings breach the surface of the water, they will increase in camber to optimize for low speed operation in air. The vehicle will change angle of attack to stay within the ground effect regime in air using firstly the submerged control surfaces. In ground regime flight the vehicle will accelerate and transition to high altitude low drag flight with optimally cambered wings.

### FIELD

The present teachings pertain to flight vehicles in general. More specifically the present teachings are related to devices and methods for transitioning from flight in water to flight in air, these same devices being capable of transitioning from air to water.

### BACKGROUND

At present, all known scalable fixed wing breaching efforts have resulted in a tip stall during breaching, ending in a complete loss of altitude and impact with the water surface.

The conflicting requirements of subsea operation and flight in air have not been resolved. The first conflict is between survey speed and breaching speed.

Breaching speed is the minimum speed for the vehicle to fly in air. In order for a vehicle to transition from flight in water to flight in air, breaching speed must be achieved while the vehicle is in water.

Survey speed is the speed at which the vehicle is designed to travel most efficiently underwater, typically while using side scan sonar to survey a subsea landscape. Side scan sonar and other acoustic sensors require a survey speed of approximately three knots. Therefore the vehicle must be efficient at survey speed and the vehicle must be capable of achieving breaching speed.

The conflicting requirements between breaching speed and survey speed are made more challenging by buoyancy. The more buoyant the vehicle, the greater the wing lifting force must be to counter the buoyancy and maintain depth. Because lifting forces are proportional to induced drag, the greater the buoyancy, the greater the induced drag, and therefore the lower the mission time. But if weight is added to counter buoyancy during subsea operations, then stall speed during the breaching event is negatively affected, i.e. the breaching speed must be greater because the vehicle is heavier, noting that increasing the planform area of the lifting surfaces will increase the buoyancy.

Further, the conflict between water and air lifting forces must be addressed. To control flight depth underwater the wing of the device must generate a lifting force in opposition to buoyancy. To control flight altitude in air the wing must generate a lifting force in opposition to the weight of the vehicle. Buoyancy and weight have opposite directions; therefore, the lifting forces have opposite directions. Previous attempts addressed the inversion of the required lifting forces by taking a negative angle of attack with the vehicle when in water in order to create lift in the opposite direction, such as when a fixed wing aircraft is flying upside down. This increases the drag component of the fuselage by increasing both the coefficient of drag and the frontal area, and in this approach the optimum wing L/D ratio in water is not available because of the extreme angle of attack needed to generate lift in the opposite direction. This also increases the drag of the horizontal stabilizer, because its net pitching effect on the vehicle must be reversed from its flight in air configuration to prevent negative static stability in water.

### SUMMARY

The present teachings pertain to hybrid flight vehicles and associated methods that allow for a scalable transition from underwater operation to fixed wing flight in air. The same devices being capable of transition from flight in air to flight in water.

The breaching event in the present teachings is composed of multiple stages: water ascent, transition, boundary layer flight, and air ascent. The vehicle of the present teachings ascends the water column in its highspeed water configuration by configuring the wings and propellers and using the flight in air orientation of the vehicle. As the tractor propeller of the vehicle breaches the surface of the water it changes pitch collectively and increases its rotational speed. As the wings of the vehicle breach the surface of the water, they increase in camber in order to optimize the L/D ratio. The vehicle changes angle of attack to stay within the ground effect regime of flight, i.e. within boundary layer effect from the surface of the water. In ground regime flight the vehicle of the present teachings accelerates in order to reach a speed at which it can leave the ground effect regime without stalling.

In certain aspects the present invention provides for a device capable of transitioning from flight in water to flight in air, i.e. a hybrid flight vehicle. The device includes a fuselage and a wing attached to the fuselage. The wing is capable of sustaining flight in air and in water. The device further includes a wing leading edge device and a wing trailing edge device. The leading and trailing devices are configured to change the wing L/D ratio for transitioning from water to air or from air to water. The device still further includes a pusher propeller connected at the aft of the fuselage and a pusher propeller motor driving the pusher propeller. The pusher propeller motor is equipped with a first back-EMF frequency sensor and a sensor for detecting water to air transition. The pusher propeller may be optimized for water. The device may further include a tractor propeller connected at the fore of the fuselage, and a tractor propeller motor driving the tractor propeller. The tractor propeller motor is equipped with a second back-EMF frequency sensor. The device yet further includes a tailplane. The tractor and pusher propellers have a collective pitch. The tractor propeller may be optimized for air. The pusher propeller and tractor propeller may be in contra-rotation and configured for providing roll control for preventing tip stall while transitioning. The tailplane may comprise differential control surfaces for providing roll control for preventing tip stall. The device may further comprise an acoustic or a visual sensor. The sensor is capable of transitioning from a generally downward facing direction to a generally upward facing direction. The sensor may be capable of simultaneously localizing and mapping wave forms. The sensor may also be capable of registering wind conditions.

In certain aspects, the present invention provides for a method of flight transitioning from water to air. The method includes providing a device, which contains a fuselage, a wing attached to the fuselage, a wing leading edge device attached to the wing, a wing trailing edge device attached to the wing, a pusher propeller connected at an aft of the fuselage, a pusher propeller motor driving the pusher propeller; the pusher propeller motor being equipped with a first back-EMF frequency sensor, a tailplane, and a sensor for detecting water to air transition. The method further includes activating the pusher propeller motor to provide device propulsion under water. The method even further includes sensing transition from water to air. The method yet further includes operating the wing leading edge device and a wing trailing edge device to change the wing's L/D ratio. The method still further includes sensing a first back-EMF frequency change to indicate the pusher propeller transition from water to air. The method further includes changing pusher propeller's pitch. The method may further include providing a tractor propeller connected at a fore of the fuselage. The tractor propeller motor configured for driving the tractor propeller. The tractor propeller motor is equipped with a second back-EMF frequency sensor. The tractor and pusher propellers have a collective pitch. The method may further include activating the tractor propeller motor. The method may further include sensing a second back-EMF frequency change to indicate the tractor propeller transition from water to air. The method may further comprise rotating the vehicle about a fuselage longitudinal axis prior to transitioning from water into air. The method may further comprise orienting the vehicle such that the most efficient wing L/D ratio for survey speed is used. The method may further comprise orienting the vehicle such that the most efficient wing L/D ratio for breaching is used.

In certain aspects, the present invention provides for a method for flight transitioning from air to water. The method includes providing a device which has a front and a rear. The device contains a fuselage, a wing attached to the fuselage, a wing leading edge device attached to the wing, a wing trailing edge device attached to the wing, a tractor propeller connected at a fore of the fuselage, a tractor propeller motor driving the tractor propeller a tailplane, and a sensor for detecting air to water transition. The tractor propeller motor is equipped with a first back-EMF frequency sensor. The method further includes activating the tractor propeller motor to provide device propulsion in air. The method further includes sensing transition from air to water. The method further includes operating the wing leading edge device and a wing trailing edge device to change the wing's L/D ratio. The method further includes sensing a first back-EMF frequency change to indicate tractor propeller transition from air to water. The method further includes changing the tractor propeller's pitch. The method may further include providing a pusher propeller connected at an aft of the fuselage and a pusher propeller motor driving the pusher propeller. The pusher propeller motor is equipped with a second back-EMF frequency sensor. The tractor and pusher propellers have a collective pitch. The method further includes activating the pusher propeller motor. The method further includes sensing a second back-EMF frequency change to indicate the pusher propeller transition from air to water. The method may further include rotating the vehicle about a fuselage longitudinal axis prior to transitioning from air into water. The method may further include orienting the vehicle such that the most efficient wing L/D ratio for survey speed is used. The method may further include orienting the vehicle such that the most efficient wing L/D ratio for breaching is used. The method of claim may further include entering the water at low speed and high angle of attack, utilizing collective pitch of propellers to feather each blade, reducing frontal area, and lowering the coefficient of drag. The method may further include entering the water at low speed and low angle of attack, flaring up the front, bringing forward speed to zero, submerging the rear in the water, utilizing collective pitch of propellers to feather each blade, reducing frontal area, and lowering the coefficient of drag. The method may further include entering the water at low speed and low angle of attack, landing on a water surface, moving forward or backward, and utilizing flight surfaces for submerging.

### BRIEF DESCRIPTION OF THE DRAWINGS

FIG. 1A shows a side view of an exemplary configuration of the vehicle architecture of the present teachings;

FIG. 1B shows a top view of an exemplary configuration of the vehicle architecture of the present teachings;

FIG. 1C shows a rear view of an exemplary configuration of the vehicle architecture of the present teachings;

FIG. 2A illustrates the vehicle lifting force (downward) in opposition to buoyancy (upward), the vehicle is in water and oriented for flight in air, i.e. flight orientation;

FIG. 2B illustrates the vehicle lifting force in opposition to buoyancy, the vehicle is in water and oriented for efficient flight in water, i.e. survey orientation;

FIG. 2C illustrates the vehicle lifting force in opposition to gravity, i.e. weight, the vehicle is in air and oriented for flight in air, i.e. flight orientation;

FIG. 3A illustrates the vehicle while submerged and ascending, the vehicle is in water and oriented for flight in air, i.e. flight orientation;

FIG. 3B illustrates the vehicle transitioning from water into air with the tractor propeller in air and the wings, tail, and pusher propeller in water; the tractor propeller is configured for low speed in air and the pusher propeller is configured for high speed in water;

FIG. 3C illustrates the vehicle flying at breaching speed within the ground effect regime, the tractor propeller is configured for low speed in air and the pusher propeller is configured for high speed in water;

FIG. 3D illustrates the vehicle accelerating to cruise speed while departing the ground effect regime;

FIG. 3E illustrates the vehicle configured for cruise speed;

FIG. 4 illustrates the vehicle configured for subsea travel at survey speed.

### DETAILED DESCRIPTION

The term “gravity”, as used herein, means a natural phenomenon by which objects with mass are attracted to one another, viz., the acceleration of gravity multiplied by the mass of the vehicle equals the weight of the vehicle;

the term “downward”, as used herein, means the direction of the net total gravitational field acting on the vehicle;

the term “upward”, as used herein, means the direction opposite of the net total gravitational field acting on the vehicle;

the term “buoyancy”, as used herein, means the net total force on a submerged vehicle composed of the weight of the fluid displaced by the vehicle, minus the weight of the vehicle;

the term “airscrew”, as used herein, means a rotary device which creates a pressure differential along the axis of rotation, in an exemplary embodiment by moving one or more airfoil stacks through a fluid;

the term “contra-rotating”, as used herein, means rotation in which at least one pair of elements rotates in opposite directions;

the term “differential contra-rotating”, as used herein, means contra-rotation where the rotational speed of at least two airscrew may be controlled independently of each other, allowing net torque and net thrust to be controlled independently;

the term “tractor propeller”, as used herein, means an airscrew located such that it generates a force which puts the rotational shaft of the airscrew in tension, herein the tractor propeller may be configurable to different flight regimes by collective pitch, the tractor propeller may also be configured to control roll by differential contra-rotation;

the term “pusher propeller”, as used herein, is an airscrew located such that it generates a force which puts the airscrew rotational shaft in compression, herein the pusher propeller may be configured for different flight regimes by collective pitch, the pusher propeller may also be configured to control roll by differential contra-rotation;

the term “fuselage”, as used herein, means the central structure of the vehicle;

the term “lifting force”, as used herein, means a force generated by the flow of a fluid past a surface, that force used to counter the weight of the vehicle in air or the buoyancy of the vehicle in water, noting that the lifting force used to counter the buoyant force can be generated in the air orientation with high angle of attack or in the survey configuration with low angle of attack, the lifting force may be conditioned by control surfaces to provide control authority to the vehicle;

the term “L/D ratio”, as used herein, refers to the lift to drag ratio of a device, lift is the useful product of a device and drag is the unneeded consequence of lift;

the term “wing”, as used herein, means an airfoil stack that generates a lifting force, herein the wing may be configurable to adjust the L/D ratio;

the term “aspect ratio”, as used herein, is the ratio of the square of the wingspan divided by the wing area;

the term “leading edge device”, as used herein, is a device located at the leading edge of a wing that conditions the L/D ratio of the wing to the current flight regime, in general terms a leading edge device is a device located in the forward portion of the wing that increases lift and allows a greater angle of attack with the airflow before stalling, this can be accomplished with an increase in camber and/or by opening slats which allow flow from the bottom of the wing to the top of the wing, but is not limited to any specific embodiment and may be embodied in the wing itself;

the term “trailing edge device”, as used herein, in general terms is a device located at the trailing edge of a wing that conditions the L/D ratio of the wing to the current flight regime, this can be accomplished with an increase in camber at the trailing edge, but is not limited to any specific embodiment and may be embodied in the wing itself;

the term “tailplane”, as used herein, means an airfoil stack at the aft of the vehicle used to effect the angle of attack of the vehicle;

the term “water column”, as used herein, refers to the distance of water between a submerged vehicle and the surface of the water;

the term “velocity”, as used herein, means the rate of change of the position of a vehicle measured in the direction of the roll axis of the vehicle;

the term “hybrid flight vehicle”, as used herein, means a vehicle that can fly in air and water, viz., fluid dynamic lifting forces used to overcome gravity in air and buoyancy in water;

the term “breaching”, as used herein, means transition from flight in water to flight in air;

the term “breaching speed”, as used herein, means the minimum speed for a vehicle to fly in air;

the term “stall speed”, as used herein, is synonymous with “breaching speed” when used in reference to the invention outlined herein, when used in reference to prior art of fixed wing flight it is defined as the speed at which the vehicle lift is equal to the vehicle weight;

the term “hotel load”, as used herein, means the net power load of the vehicle not including propulsion;

the term “survey speed”, as used herein, indicates speed at which the vehicle consumes the least amount of power while meeting the requirements of side scan sonar data acquisition or other mission defined data acquisition, the defining factors are coefficient of drag, frontal area, hotel load, and net buoyancy, typical survey speeds are about an order of magnitude less than typical breaching speeds;

a “side scan sonar” device, as used herein, is a device that emits conical pulses in the sound frequency spectrum (from about 75 kHz to about 900 kHz) perpendicular to the path of the vehicle and measures the intensity of the reflected pulses over time, knowing the speed and direction of the sensors, an image of the reflective surfaces can be reconstructed;

the term “scalable”, as used herein, means a vehicle architecture that can be subscale tested, with well understood scaling factors for geometrical similarity, kinematic similarity, and dynamic similarity, while enabling transition to meet increased workloads such as carrying the weight of a sensor payload;

the term “transition”, as used herein, means transition from flight in water to flight in air;

the term “stall”, as used herein, means that the lift required for flight is not available;

the term “tip stall”, as used herein, means that the lift required for flight is not available and that an unwanted roll torque is induced which leads to further reduction of the net lifting force;

the term “collective pitch”, as used herein, refers to the change of the pitch angle of the propeller blades collectively, i.e., all at the same time, and independent of their position, resulting in an increase or decrease in total force derived from the propeller; collective pitch is used here to adapt a propeller from one flight regime to another, e.g. from water into air;

the term “boundary layer”, as used herein, refers to a region of air adjacent to a surface of the fluid, boundary layer is affected by the surface when there is a difference in velocity between the fluid and the surface, the effect is characterized by the kinetic theory of gas as an exchange of momentum and more commonly in aerodynamics by shear force in the fluid, boundary layer flight is the defining phenomenon of “ground effect” flight;

the term “ground effect regime”, as used herein, refers to flight regime in which enhanced performance for an aerodynamic lifting device is found, i.e. flight within the boundary layer adjacent to the water surface, flight within the ground effect regime reduces the stall speed;

the term “motor”, as used herein, is defined as a device which imparts rotary motion, herein the non-limiting exemplary embodiment is a brushless DC electric motor;

the term “back-EMF frequency sensor”, as used herein, is defined as a sensor that senses propeller angular speed, in an exemplary embodiment the sensing of electromotive force generated by the change of magnetic flux through a conductor is available if a brushless DC electric motor is used, for this exemplary embodiment the cyclic rate of change of the electromotive force is representative of the propeller angular speed, given that the motor configuration is known, the cyclic rate of change of the electromotive force indicates the angular speed of said electric motor, noting that this electromotive force is generated by the conductors of the electric motor moving through the permanent magnet field of the electric motor, this is in opposition to the electromotive force supplied to said electric motor to induce mechanical work;

the term “blade”, as used herein, is defined as an airfoil stack which generates thrust by rotation about a longitudinal axis;

the term “feathered”, as used herein, is defined as rotating the blades of a collective pitch propeller such that they are parallel to the airflow and have minimal drag and frontal area;

the term “flaring”, as used herein, is defined as raising of the nose of the vehicle, i.e. inducing a high angle of attack to slow the descent rate and bring the forward speed to approximately zero;

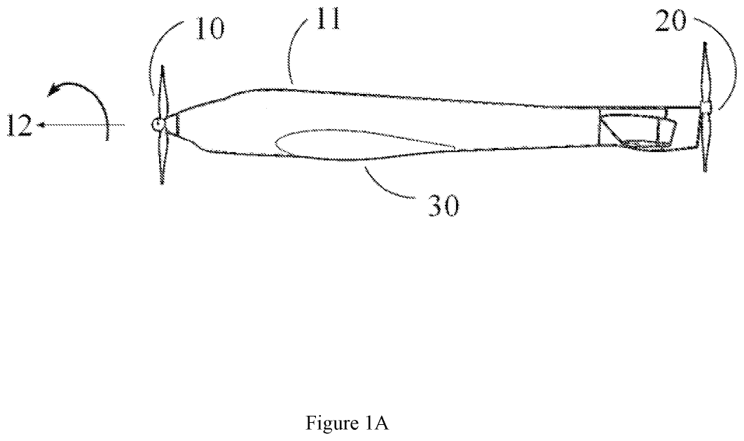

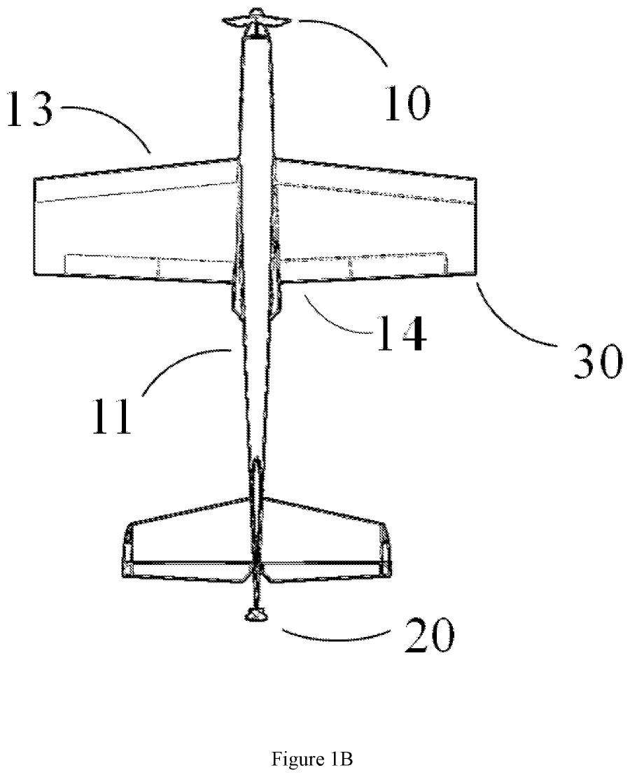

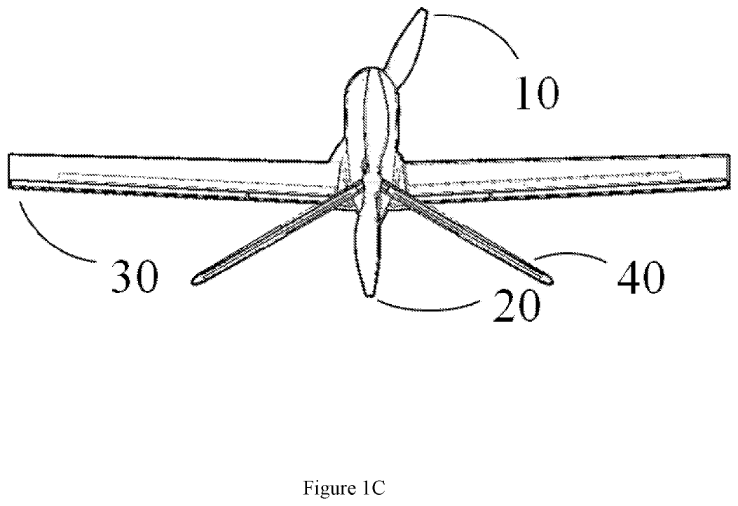

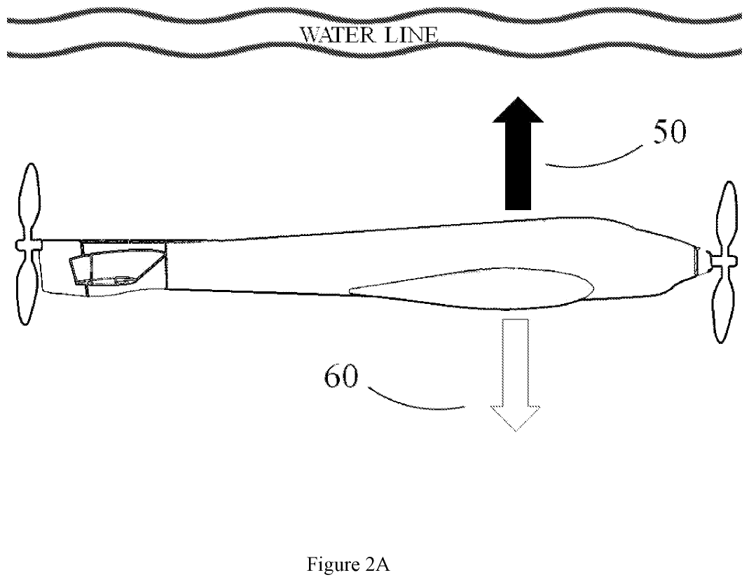

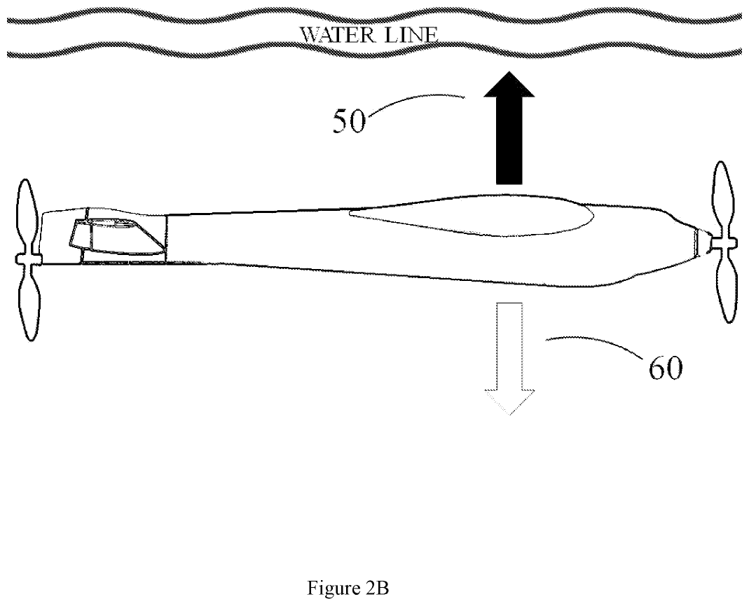

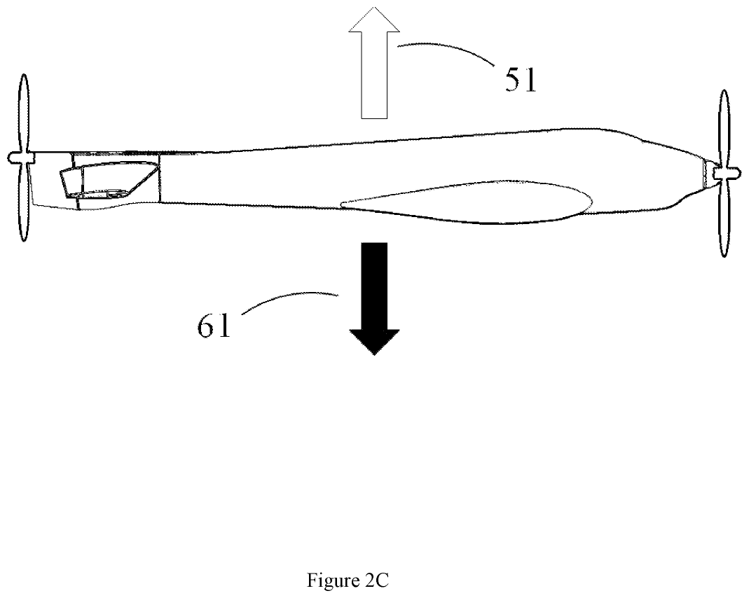

The hybrid flight vehicle of the present teachings is illustrated in FIGS. 1A, 1B and 1C. In an exemplary embodiment the tractor propeller 10 is attached to fuselage 11 and resides at the fore of the vehicle. It is in contra-rotation with pusher propeller 20, which in an exemplary embodiment is attached to fuselage 11 at the aft of the vehicle. Lifting body, wing 30, is attached to fuselage 11 and provides lifting forces 51 and 60 to the vehicle, as illustrated in FIGS. 2A, 2B and 2C. In an exemplary embodiment tailplane 40 is attached to fuselage 11 at the aft of the vehicle, as illustrated in FIG. 1C.

Though the embodiment of the vehicle presented herein depicts pusher propeller as a single propeller, the invention is not limited to this configuration. For example, it is possible to use a contra-rotating pusher propeller to control roll as the main wing exits the water, thereby preventing tip stall.

Though the embodiment of the vehicle presented herein depicts tractor propeller as a single propeller, the invention is not limited to this configuration. For example, it is possible to use a contra-rotating tractor propeller to control roll as the main wing exits the water, thereby preventing tip stall.

Although an exemplary embodiment of the vehicle presented herein depicts the tailplane in an aft position, it should be clearly understood that the present invention is not limited to any specific embodiment of the tailplane configuration. Alternative positions are possible and the shown position and configuration of the tailplane are not defining to the present teachings.

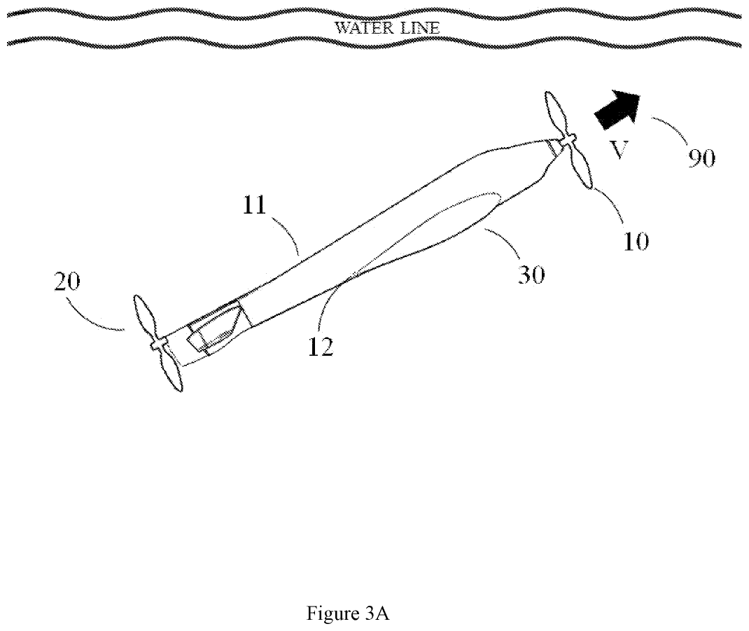

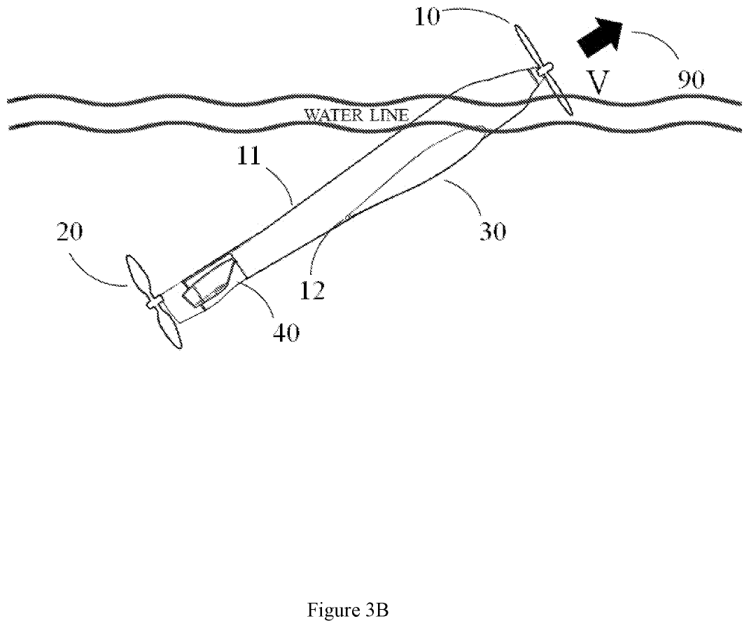

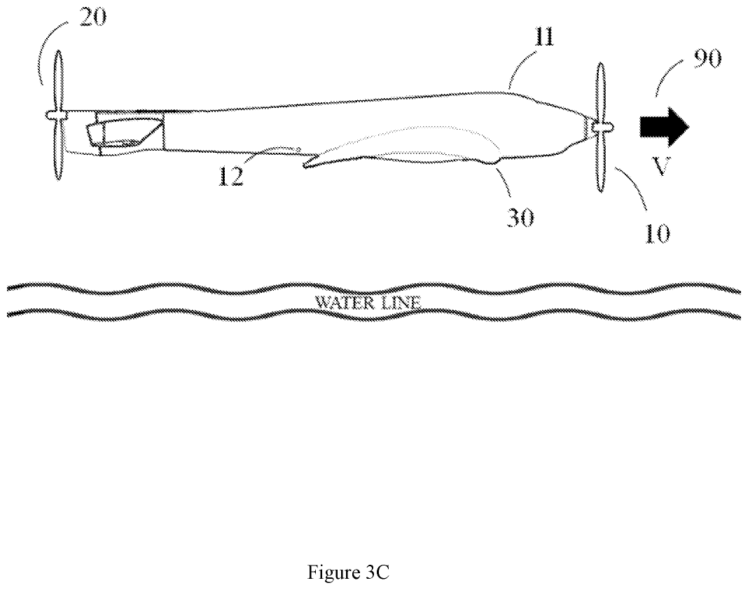

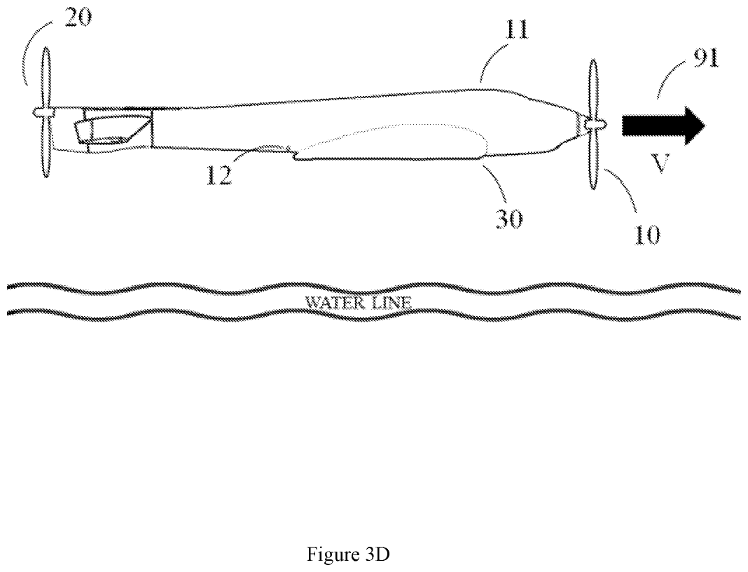

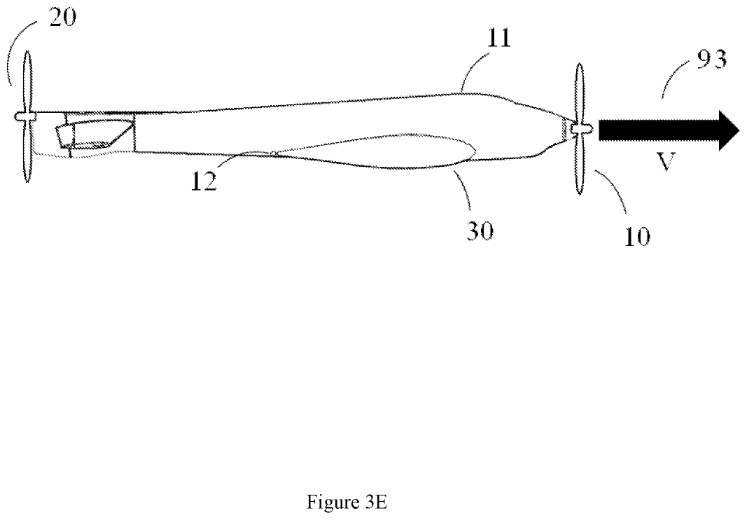

The device of the present teachings is configured to have a reduced frontal area. In water, the reduced frontal area allows for a higher speed transition from water to air. Leading edge device 13 and trailing edge device 14 are used to minimize drag in water and minimize stall speed in air. Utilizing collective pitch propellers allows each propeller to adapt from water to air as they breach. Tractor propeller 10, FIG. 1A, is configured to maximize thrust for breaching, both in water and in air, using collective pitch. Pusher propeller 20, FIG. 1A, is configured to sustain thrust during transition of tractor propeller 10 from water to air and uses collective pitch to sustain optimum thrust through the transition event. Tractor propeller 10 may be optimized for air, while pusher propeller 20 may be optimized for water. Pressure sensors 12, FIG. 3B, behind wing 30 may indicate transition. A change in propeller speed as it transitions may be used as an indicator. These indicators can trigger transition control strategies, including collective pitch optimization and high lift device optimization for low speed flight in air. Concurrently the pitch control strategy may use tailplane 40, FIG. 1C, to pitch down the nose of the aircraft as it leaves the water to keep the aircraft within the ground effect regime, lowering stall speed. Note that in the exemplary embodiment the tailplane 40 is in the water during the downward pitch maneuver. The control surfaces of the tailplane may be used independently so that they provide roll control authority to prevent tip stall in transition. Downward winglets on the wing may be used to significantly increase the ground effect phenomena.

The following disclosure details the order of operations by which the vehicle of the present teachings transitions from flight in water to flight in air. The order of operations starts in the survey orientation, see FIG. 2B, with the propellers and wing optimized for water.

In the survey orientation the vehicle may descend so that it can use buoyancy to reach peak velocity during ascent of the water column. At or before optimum depth the vehicle will roll to the flight configuration, see FIG. 2A.

After reaching optimum depth, breaching is initiated by ascent of the water column, see FIG. 3A. The front of the vehicle breaks the surface of the water at the maximum submerged speed 90 and the tractor propeller 10 transitions from water to air, see FIG. 3B. Due to the transition from water to air, the resistance on propeller 10 decreases, resulting in increased rotational speed. The change in speed will result in increased back-EMF frequency from propeller 10 motor. The increase in back-EMF frequency triggers a change in collective pitch so that propeller 10 is optimized for low speed flight 90 in air. As the vehicle continues its ascent, sensors located on fuselage 11 or wing 30 indicate that wing 30 has transitioned from water to air, and wing 30 changes camber to optimize for low speed flight in air. Tailplane 40 while still submerged in the water, see FIG. 3B, is used to change the angle of attack of the vehicle so that the vehicle stays within ground effect regime of the surface of the water.

The pusher propeller 20 transitions from water to air. Due to the change in fluid, the resistance on propeller 20 decreases, resulting in increased rotational speed. The change in speed results in increased back-EMF frequency from propeller 20 motor. The increase in back-EMF frequency triggers a change in collective pitch so that propeller 20 is optimized for low speed flight 90 in air. The vehicle enters the boundary layer flight.

In boundary layer flight, see FIGS. 3C and 3D, the collective pitch orientation of propellers 10 and 20 is optimized for low speed flight in air. Wing 30 is in its maximum cambered configuration, optimized for low speed flight in the ground effect regime. Once the vehicle is in flight in the ground effect regime it accelerates to a speed 91 where flight can be sustained beyond the ground effect regime, see FIG. 3E. The camber is minimized to reduce drag and optimize range at increased speed 93.

In the present teachings the conflict between survey speed 89 and breaching speed is resolved by using low aspect ratio wing 30 that changes its lift and drag coefficients through using leading and trailing edge devices. Low aspect ratio wing 30, see FIG. 1B, has a small frontal area, low volume/low buoyancy, and in its uncambered configuration has a low drag coefficient in water. This allows for both, efficient low speed operation, while using acoustic sensors, and high-speed operation in water to initiate transition to air.

In some aspects, the device of the present teachings is capable of entering the water at low speed, high angle of attack with respect to the surface of the water, with the collective pitch of the propellers feathered to reduce frontal area and lower the coefficient of drag.

In some aspects, the device of the present teachings is capable of entering the water at low speed, low angle of attack (acute with the water surface), then flaring to produce an obtuse angle of attack with the water (nose up), bringing the forward speed to zero. The device will then dive into the water tail first while the collective pitch of the propellers is feathered to reduce frontal area and lower the coefficient of drag.

In some aspects, the device of the present teachings is capable of entering the water at low speed, low angle of attack (low angle of attack with the surface of the water) by initial landing on the water surface, and then by moving either forward or backward, allowing the flight surfaces to submerge the device.

In some aspects, the device of the present teachings, being able to orient its acoustic sensors either upward or downward, is capable of simultaneously localizing and mapping wave forms using acoustic sensors and visual sensors.

In some aspects, the device of the present teachings, being able to orient its acoustic sensors either upward or downward, is capable of gathering the wind conditions data using acoustic and visual sensors and optimizing exit flight utilizing the wind speed and direction information.

In some aspects, the device of the present teachings is capable of choosing the trajectory to the surface of the water to provide for exiting high in the wave while utilizing optimum trajectory to maximize probability of breaching and minimize detection.

In some aspects, the device of the present teachings is capable of using non-acoustically transparent umbra and penumbra cover to obscure the required non-acoustically transparent portions of the device such as the Main Electronics Housing. The non-acoustically transparent umbra and penumbra may be shaped in the form of an object found in the sub-sea environment, such as a rock, a coral, a crustacean, and a fish. The cover may be made of a material conditioned to mimic the density and transmissibility of the mimicked object.

The method and device of the present teachings allow for transitioning at a high speed due to utilizing a low aspect ratio wing 30. The device of the present teachings performs a kick maneuver with its tailplane 40 while the tailplane is still in the water but wings 30 are in the air.

The kick maneuver includes forcing wings 30 down into ground regime flight through utilizing tailplane 40 so that stall is averted. This is aided by the low aspect ratio wings 30, which are stall resistant.

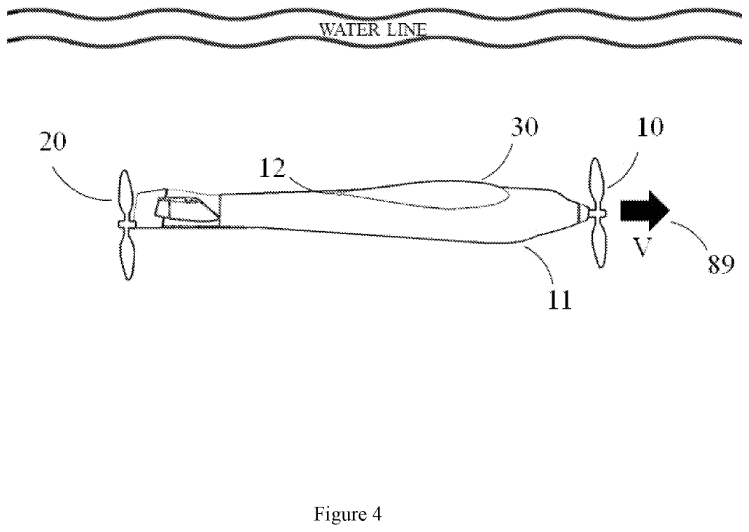

Noting that buoyancy and gravity are directly opposite in direction, the device and method of the present teachings allow for resolving the conflict between water and air lifting forces. To control depth underwater wing 30 must generate lifting force 60 in opposition to buoyancy 50, see FIGS. 2A and 2B. To control altitude in air the wing 30 must generate a lifting force 51 in opposition to the action of gravity 61, see FIG. 2C. In the vehicle of the present teachings devices are utilized for survey in water. Such devices include side scan sonar and doppler velocity logger, which may be integrated into the vehicle such that the vehicle is oriented upside-down, i.e. the vehicle is in survey orientation while performing survey work, see FIG. 4.

The method of the present teachings addresses the conflict between cruise speed and takeoff speed using the same low aspect ratio wings 30 that resolves the conflict between survey speed and launch speed. Low aspect ratio wings 30 change their lift and drag coefficients by utilizing leading edge device 13 and trailing edge device 14. This allows high speed cruise at a peak L/D because peak L/D happens at a higher speed as the wing aspect ratio is lowered. This also allows low stall speed for breaching when the high lift devices are activated.

All publications and patents mentioned herein are hereby incorporated by reference in their entirety as if each individual publication or patent was specifically and individually indicated to be incorporated by reference.

While specific embodiments of the subject matter have been discussed, the above specification is illustrative and not restrictive. Many variations will become apparent to those skilled in the art upon review of this specification and the claims below. The full scope of the invention should be determined by reference to the claims, along with their full scope of equivalents, and the specification, along with such variations.

What is claimed is:

1. A device capable of transitioning from flight in water to flight in air, said device comprising:
a fuselage;
a wing attached to the fuselage, said wing being capable of sustaining device flight in air and water;
a wing leading edge device attached to the wing and a wing trailing edge device attached to the wing, said wing leading and trailing edge devices being configured to change the wing L/D ratio for transitioning from water to air or from air to water;
a pusher propeller connected at the aft of the fuselage;
a pusher propeller motor driving the pusher propeller, the pusher propeller motor being equipped with a first back-EMF frequency sensor; and
a sensor for detecting water to air transition.

2. The device of claim 1, wherein said pusher propeller is optimized for water.

3. The device of claim 1, further comprising:
a tractor propeller connected at the fore of the fuselage;
a tractor propeller motor driving the tractor propeller, the tractor propeller motor being equipped with a second back-EMF frequency sensor;
wherein said tractor and pusher propellers have a collective pitch; and
a tailplane.

4. The device of claim 3, wherein said tractor propeller is optimized for air;

5. The device of claim 3, wherein the pusher propeller and tractor propeller, being in contra-rotation and configured for providing roll control for preventing tip stall while transitioning.

6. The device of claim 3, wherein said tailplane comprises differential control surfaces for providing roll control for preventing tip stall.

7. The device of claim 3, further comprising an acoustic or a visual sensor, said sensor being capable of transitioning from a generally downward facing direction to a generally upward facing direction.

8. The device of claim 7, wherein said sensor is capable of simultaneously localizing and mapping wave forms.

9. The device of claim 7, wherein said sensor is capable of registering wind conditions.

10. A method for flight transitioning from water to air, the method comprising:
providing a device, comprising a fuselage, a wing attached to the fuselage, a wing leading edge device attached to the wing, a wing trailing edge device attached to the wing, a pusher propeller connected at an aft of the fuselage, a pusher propeller motor driving the pusher propeller; the pusher propeller motor being equipped with a first back-EMF frequency sensor, a tailplane, and a sensor for detecting water to air transition;
activating the pusher propeller motor to provide device propulsion under water;
sensing transition from water to air;
operating the wing leading edge device and a wing trailing edge device to change the wing's L/D ratio;
sensing a first back-EMF frequency change to indicate the pusher propeller transition from water to air; and
changing pusher propeller's pitch.

11. The method of claim 7, further comprising:
providing a tractor propeller connected at a fore of the fuselage, a tractor propeller motor driving the tractor propeller, the tractor propeller motor being equipped with a second back-EMF frequency sensor, wherein said tractor and pusher propellers have a collective pitch;
activating the tractor propeller motor; and
sensing a second back-EMF frequency change to indicate the tractor propeller transition from water to air.

12. The method of 7, further comprising rotating the vehicle about a fuselage longitudinal axis prior to transitioning from water into air.

13. The method of claim 7, further comprising orienting the vehicle such that the most efficient wing L/D ratio for survey speed is used.

14. The method of claim 7, further comprising orienting the vehicle such that the most efficient wing L/D ratio for breaching is used.

15. A method for flight transitioning from air to water, the method comprising:
providing a device, said device having a front and a rear, the device comprising a fuselage, a wing attached to the fuselage, a wing leading edge device attached to the wing, a wing trailing edge device attached to the wing, a tractor propeller connected at a fore of the fuselage, a tractor propeller motor driving the tractor propeller; the tractor propeller motor being equipped with a first back-EMF frequency sensor, a tailplane, and a sensor for detecting air to water transition;
activating the tractor propeller motor to provide device propulsion in air;
sensing transition from air to water;
operating the wing leading edge device and a wing trailing edge device to change the wing's L/D ratio;
sensing a first back-EMF frequency change to indicate the tractor propeller transition from air to water; and
changing tractor propeller's pitch.

16. The method of claim 12, further comprising:
providing a pusher propeller connected at an aft of the fuselage, a pusher propeller motor driving the pusher propeller, the pusher propeller motor being equipped with a second back-EMF frequency sensor, wherein said tractor and pusher propellers have a collective pitch;
activating the pusher propeller motor; and
sensing a second back-EMF frequency change to indicate the pusher propeller transition from air to water.

17. The method of claim 12, further comprising rotating the vehicle about a fuselage longitudinal axis prior to transitioning from air into water.

18. The method of claim 12, further comprising orienting the vehicle such that the most efficient wing L/D ratio for survey speed is used.

19. The method of claim 12, further comprising orienting the vehicle such that the most efficient wing L/D ratio for breaching is used.

20. The method of claim 12, further comprising:
entering water at low speed and high angle of attack;
utilizing collective pitch of propellers to feather each blade;
reducing frontal area; and
lowering the coefficient of drag.
